(19) United States
(12) Patent Application Publication
(10) Pub. No.: US 2010/0158223 A1
(43) Pub. Date: Jun. 24, 2010

(54) METHOD, DEVICE AND SYSTEM FOR REALIZING ADVERTISEMENT SERVICES

(75) Inventors: Chen Fang, Shenzhen (CN); Changcheng Wen, Shenzhen (CN)

Correspondence Address: FutureWei Technologies, Inc.;IPR & Standards Department, 1700 Alma Drive, Suite 500, Plano, TX, 75075, US

(73) Assignee: HUAWEI TECHNOLOGIES CO., LTD., Shenzhen (CN)

(21) Appl. No.: 12/617,862

(22) Filed: Nov. 13, 2009

(30) Foreign Application Priority Data
Dec. 23, 2008 (CN) 200810240718.2

(51) Int. Cl. H04M 11/00

(52) U.S. Cl. 379/93.25

(57) ABSTRACT

A method, device, and system for realizing advertisement services are provided. The method includes: in the process of communication between a calling terminal and a called terminal, the network sends a calling information display page that carries advertisement information customized by the calling terminal to the called terminal, and/or sends a called information display page that carries advertisement information customized by the called terminal to the calling terminal. The advertisement information includes voice, videos, pictures and texts. The present invention enables a terminal to view the advertisements on the calling advertisement page or the called advertisement page as required at any time before or after a conversation.

### CROSS-REFERENCE TO RELATED APPLICATION

This application claims priority to Chinese Patent Application No. 200810240718.2, filed on Dec. 23, 2008, which is hereby incorporated by reference in its entirety.

### FIELD OF THE INVENTION

The present invention relates to wireless communication technologies, and in particular, to a method, device, and system for realizing advertisement services.

### BACKGROUND OF THE INVENTION

The communication advertisements in a telecom network are primarily voice Ring Back Tone (RBT) advertisements, including: a voice advertisement played in place of a ring tone when a telephone terminal user receives a call, or a voice RBT advertisement played after the telephone terminal user originates a call until the called party answers the call. The voice advertisements are received by the user passively, and only one mode of voice advertisements is provided.

As an emerging advertisement industry, Internet advertisements are diversified in terms of the form and the content. Internet advertisements come in the following three forms:

(1) WEB page advertisement: A WEB page advertisement refers to an advertisement that appears in the browser automatically when the user opens a WEB page. WEB page advertisements are rich in forms and easy to make, and are the main advertisement mode on the Internet.

(2) Search engine advertisement: A search engine advertisement matches a keyword input by a user with the advertisement information of an advertiser through keyword search and database technologies. The advertisement may be displayed on one side of the search result page to the user, or displayed in the search result.

(3) Email advertisement: An email with advertisements is sent to the user by either a network service provider or an advertiser. The user may also subscribe to the advertisements from the advertiser according to the hobbies of the user.

Compared with a telecom network advertisement, an Internet advertisement provides more diversified contents and services. At present, with the development of Internet technologies and telecom network technologies, network convergence becomes a megatrend. The difference between Internet services and telecom network services is being phased out. The mutual penetration of advertisement services promotes perfection and maturity of the telecom network advertisement service.

FIG. 1 is a schematic diagram of a method for playing a voice RBT advertisement in the prior art. The specific processing is as follows:

A calling terminal originates a call to a called terminal through a switching network; the switching network locates the called terminal, forwards the call request of the calling terminal to the called terminal, and at the same time, sends to the RBT platform a request for playing a voice RBT advertisement; the voice RBT advertisement has been customized on the RBT platform by the called terminal beforehand through an RBT management module; the RBT platform retrieves the foregoing voice RBT advertisement, sends the advertisement to the calling terminal through the switching network, and plays it on the calling terminal; and the called terminal responds to the call request and establishes a call connection, and the RBT platform finishes playing the voice RBT advertisement.

In the process of realizing the present invention, the inventor finds at least these defects in the foregoing method for playing the voice RBT advertisement: the user has to receive the voice RBT advertisement passively before the conversation, and the voice RBT advertisement is effective before the conversation and its lifecycle is short; and the service is limited to only audio advertisements.

### SUMMARY OF THE INVENTION

The objectives of the embodiments of the present invention are fulfilled through the following technical solution.

A method for realizing an advertisement service includes:

receiving a call request originated by a calling terminal;

generating a calling information display page according to advertisement information customized by the calling terminal and identifier information of the calling terminal; and

sending the call request and the calling information display page to a called terminal, and establishing a conversation between the calling terminal and called terminal, where:

the calling information display page is configured for the called terminal to view the advertisement information customized by the calling terminal during or after the conversation process.

A method for realizing an advertisement service includes:

receiving a call request originated by a calling terminal;

generating a called information display page according to advertisement information customized by a called terminal and identifier information of the called terminal; and

sending the call request to the called terminal, sending the called information display page to the calling terminal, and establishing a conversation between the calling terminal and the called terminal, where:

the called information display page is configured for the calling terminal to view the advertisement information customized by the called terminal during or after the conversation process.

A method for realizing an advertisement service includes:

receiving a call request originated by a calling terminal;

generating a calling information display page according to advertisement information customized by the calling terminal and identifier information of the calling terminal; generating a called information display page according to advertisement information customized by a called terminal and identifier information of the called terminal; and

sending the call request to the called terminal, sending the calling information display page to the called terminal, sending the called information display page to the calling terminal, and establishing a conversation between the calling terminal and the called terminal, where:

the calling information display page is configured for the called terminal to view the advertisement information customized by the calling terminal during or after the conversation process, and the called information display page is configured for the calling terminal to view the advertisement information customized by the called terminal during or after the conversation process.

An device for realizing an advertisement service includes:

a first page generating module, configured to generate a calling information display page according to advertisement information customized by a calling terminal and identifier information of the calling terminal after receiving a call request from the calling terminal; and

a first conversation processing module, configured to: send the call request and the calling information display page generated by the first page generating module to a called terminal, and establish a conversation between the calling terminal and the called terminal, where the calling information display page is configured for the called terminal to view the advertisement information customized by the calling terminal during or after the conversation process.

A device for realizing an advertisement service includes:

a called information display page generating module, configured to generate a called information display page according to advertisement information customized by a called terminal and identifier information of the called terminal after receiving a call request from a calling terminal; and

a conversation processing module, configured to: send the call request to the called terminal, send the called information display page generated by the called information display page generating module to the calling terminal, and establish a conversation between the calling terminal and the called terminal, where the called information display page is configured for the calling terminal to view the advertisement information customized by the called terminal during or after the conversation process.

A system for realizing an advertisement service includes:

a communication server, configured to: receive a call request originated by a calling terminal, where the call request includes identifier information of the calling terminal and a called terminal; send an information display page address request to a WEB server for requesting the information display page address of the calling terminal and/or called terminal; send the information display page address to the called terminal and/or calling terminal; establish a conversation between the calling terminal and the called terminal, where the information display page address is configured for the terminal to view the advertisement information customized by the peer terminal during or after the conversation process;

the WEB server, configured to: generate an information display page according to the advertisement information customized by the terminal and the identifier information of the terminal, and return an information display page address corresponding to the identifier information according to the terminal identifier information carried in the information display page address request of the communication server.

### BRIEF DESCRIPTION OF THE DRAWINGS

To make the technical solution under the present invention clearer, the accompanying drawings for illustrating the embodiments of the present invention are outlined below. Evidently, the accompanying drawings are exemplary only, and those skilled in the art can derive other drawings from such accompanying drawings without creative work.

FIG. 1 is a schematic diagram of a method for playing a voice RBT advertisement in the prior art;

FIG. 2 shows a process of a method for realizing a call-based advertisement service in a first embodiment of the present invention;

FIG. 3 shows a process of a method for realizing a call-based advertisement service in a second embodiment of the present invention;

FIG. 4 shows a process of a method for realizing a call-based advertisement service in a third embodiment of the present invention;

FIG. 5 shows a process of a method for realizing a call-based advertisement service in a fourth embodiment of the present invention;

FIG. 6 is a schematic diagram of a method for realizing a call-based advertisement service in a fifth embodiment of the present invention;

FIG. 7 shows a structure of an device for realizing a call-based advertisement service in a sixth embodiment of the present invention;

FIG. 8 shows a structure of an device for realizing a call-based advertisement service in a seventh embodiment of the present invention;

FIG. 9 shows a structure of an device for realizing a call-based advertisement service in an eighth embodiment of the present invention; and

FIG. 10 shows a structure of a system for realizing a call-based advertisement service in a ninth embodiment of the present invention.

### DETAILED DESCRIPTION OF THE INVENTION

To make the present invention clearer, the following describes the present invention with reference to accompanying drawings and exemplary embodiments, and such embodiments are not intended to limit the present invention. Those skilled in the art can derive other embodiments from the embodiments herein without creative work, and all such embodiments are covered by the scope of protection of the present invention.

### First Embodiment

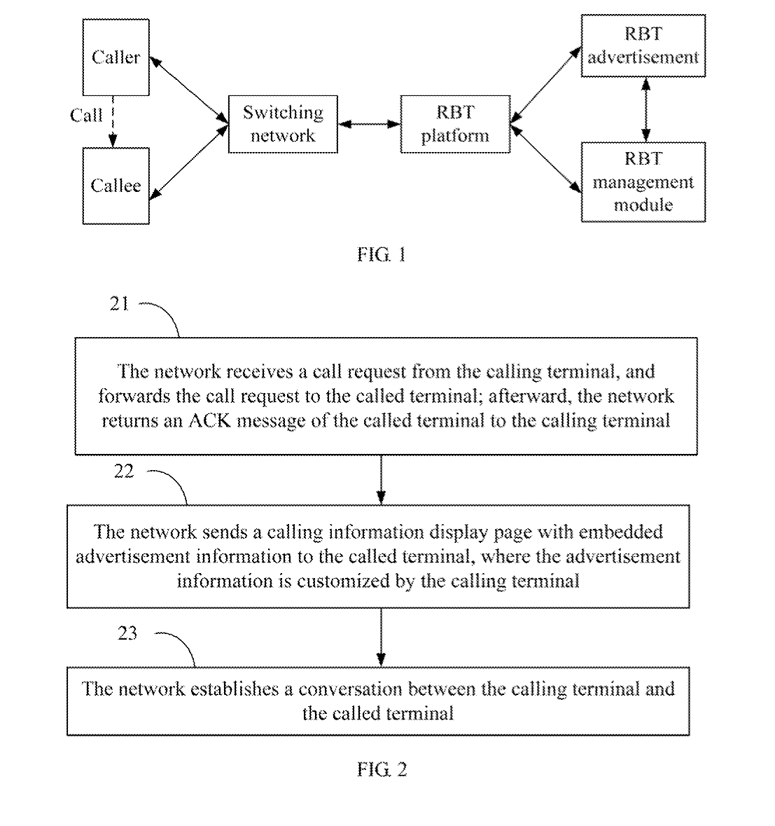

FIG. 2 shows a process of a method for realizing a call-based advertisement service in this embodiment. This embodiment enables the called terminal to display the advertisement information customized by the calling terminal when the calling terminal originates a call to the called terminal, and includes the following blocks:

Block 21: the network receives a call request from the calling terminal, and forwards the call request to the called terminal. Afterward, the network returns an ACK message of the called terminal to the calling terminal.

After receiving the call request sent by the calling terminal to the called terminal, the network returns a response to the calling terminal. The network locates the called terminal according to the call request, and forwards the call request to the called terminal.

After receiving the ACK message to the call request from the called terminal, the network returns the ACK message to the calling terminal. The ACK message is configured to notify the calling terminal that the called terminal has received the call request.

Block 22: the network sends a calling information display page with embedded advertisement information to the called terminal, and the advertisement information is customized by the calling terminal.

The network obtains the pre-stored advertisement information customized by the calling terminal and identifier information of the calling terminal user. The identifier information includes a number of the calling terminal user. The network generates the calling information display page, with embedded advertisement information of the calling terminal according to the obtained information.

The network sends the calling information display page to the called terminal.

Block 23: The network establishes a conversation between the calling terminal and the called terminal.

After receiving the ACK message to the calling information display page from the called terminal, the network forwards the ACK message to the calling terminal.

Afterward, the network forwards the response message sent by the calling terminal to the called terminal. In this way, the network establishes a conversation between the calling terminal and the called terminal.

The calling information display page has been stored in the called terminal all the time. Therefore, the called terminal may choose to view the advertisement information embedded in the calling information display page during or after the conversation.

In block 22, the network may also send a called information display page with embedded advertisement information to the calling terminal, and the advertisement information is customized by the called terminal; or, the network may send the calling information display page customized by the calling terminal to the called terminal and send the called information display page customized by the called terminal to the calling terminal simultaneously. The foregoing information display page has been stored in the terminal all the time. Therefore, the terminal may choose to view the advertisement information embedded in the information display page during or after the conversation.

### Second Embodiment

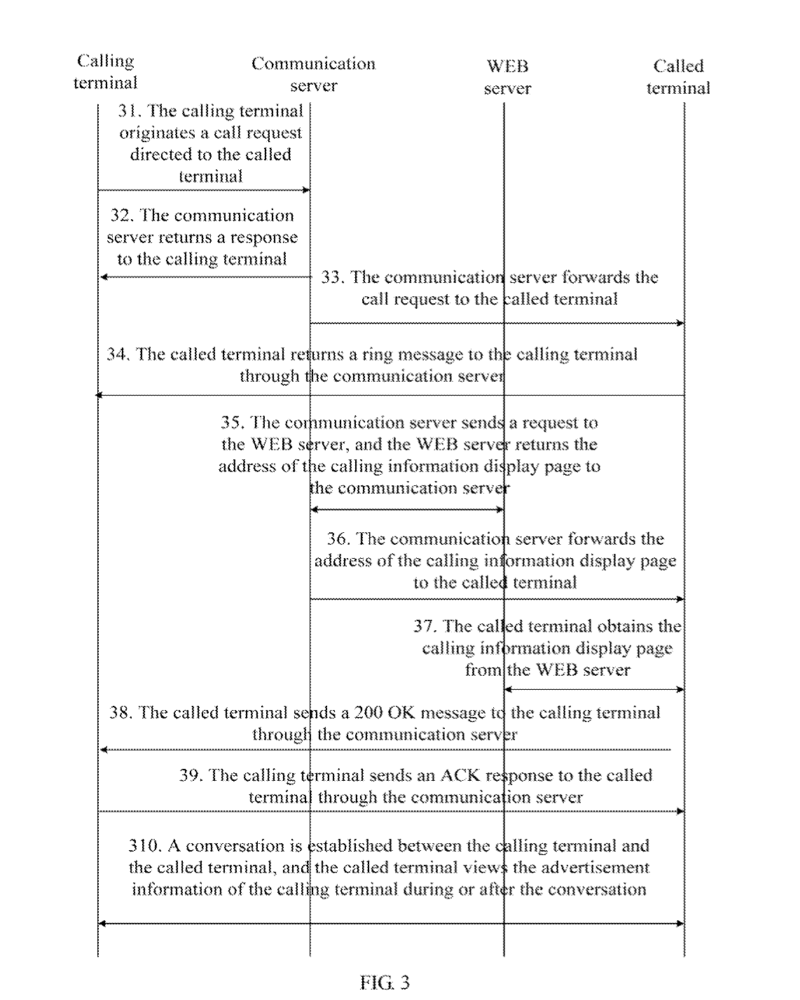

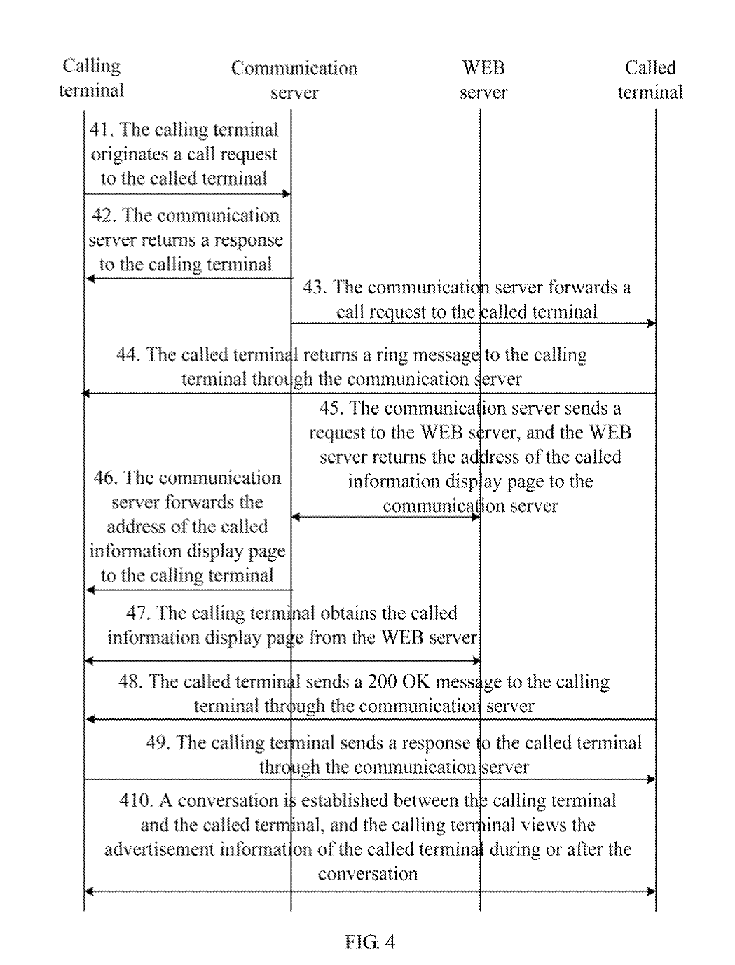

FIG. 3 shows a process of a method for realizing a call-based advertisement service in this embodiment. This embodiment enables the called terminal to display the advertisement information customized by the calling terminal when the calling terminal originates a call to the called terminal, and includes the following blocks:

Block 31: The calling terminal originates a call request directed to the called terminal.

The calling terminal sends the call request to the communication server.

Before originating the call request directed to the called terminal, the calling terminal user needs to log in the WEB server through a Personal Computer (PC) first. Afterward, the WEB server displays a service selection page to the calling terminal user. The calling terminal user selects the calling information display service in the home page service area in the service selection page. Afterward, the WEB server displays selection information to the calling terminal user. The selection information indicates whether to embed an advertisement into the calling information display page (the user and the service provider share the revenues from clicks of the advertisement embedded in the page). If the calling terminal user chooses to embed an advertisement, the WEB server sends an advertisement information customization page to the calling terminal user, and provides various classified advertisements for selection. The calling terminal user may select the advertisement information according to hobbies. The advertisement information supports voice, videos, pictures, and texts.

After the calling terminal user finishes selecting the advertisement information, the WEB server stores the selected advertisement information and the identifier information of the calling terminal user into the background database. The identifier information includes the number of the calling terminal user, and is configured to associate the advertisement information of the terminal with the terminal. In this way, in the subsequent call processing, the WEB server may generate the calling information display page with embedded WEB advertisement information of the calling terminal according to the advertisement information and the identifier information of the calling terminal.

Block 32: After receiving the call request, the communication server returns a response to the calling terminal.

The response returned by the communication server to the calling terminal indicates that the communication server has received the call request of the calling terminal.

Block 33: The communication server forwards the call request to the called terminal.

The communication server locates the called terminal according to the call request, and forwards the call request to the called terminal.

The communication server forwards the call request to the called terminal in this way: If the called terminal and the communication server are in the same network, the communication server forwards the call request to the called terminal directly; if the called terminal and the communication server are in different networks, the communication server queries the network where the called terminal resides, and then forwards the call request to another communication server in the network, and the another communication server forwards the call request to the called terminal.

Block 34: After receiving the call request, the called terminal returns a ring message to the calling terminal through the communication server. The ring message indicates that the called terminal has received the call request.

Block 35: The communication server requests the WEB server for the address of the calling information display page, and the WEB server returns the address to the communication server.

The communication server requests the WEB server for the address of the calling information display page with embedded WEB advertisement information of the calling terminal. According to the stored advertisement information selected by the calling terminal and the identifier information of the calling terminal user, the WEB server generates a calling information display page with embedded WEB advertisement information of the calling terminal. The WEB advertisement information includes advertisement links. The WEB server returns the address information of the calling information display page to the communication server. The call request carries the identifier information of the calling terminal and the called terminal. Therefore, the communication server may add the identifier information of the calling terminal into the request sent to the WEB server. Afterward, because the WEB server stores the identifier information of the calling terminal and the advertisement information selected by the calling terminal, the WEB server may obtain the stored advertisement information selected by the calling terminal according to the identifier information of calling terminal in the request of the communication server, and generate the calling information display page.

Block 36: The communication server forwards the address information of the calling information display page to the called terminal.

Block 37: The called terminal obtains the calling information display page from the WEB server.

Based on the address information of the calling information display page, the called terminal requests the calling information display page of the calling terminal from the WEB server. The WEB server sends the calling information display page to the called terminal, and the called terminal displays the calling information display page, and obtains the number information of calling terminal and WEB advertisement information in the calling information display page.

At this time, if the called terminal is interested in the advertisement information embedded in the calling information display page, the called terminal may click the advertisement link to view the advertisement information.

Block 38: The called terminal accepts the call request of the calling terminal, and sends a 200 OK message to the calling terminal through the communication server.

Block 39: After receiving the 200 OK message, the calling terminal returns an ACK response to the called terminal through the communication server.

Block 310: A conversation is established between the calling terminal and the called terminal. The called terminal views the advertisement information of the calling terminal during or after the conversation.

After the foregoing processing, the network establishes a conversation between the calling terminal and the called terminal, and the calling terminal talks with the called terminal.

During or after the conversation, the called terminal may choose to continue viewing the calling information display page of the calling terminal. If the called terminal is interested in the advertisement information embedded in the calling information display page, the called terminal may click the advertisement link to view the advertisement information.

Because the calling information display page has been stored in the called terminal all the time, this embodiment enables the called terminal to view the advertisement information embedded in the calling information display page before and after the conversation, and to click the advertisement link to view the advertisement information, thus benefiting the calling terminal. The calling information display page displays only the advertisement link rather than the whole advertisement content, thus preventing negative feeling to the called terminal when the whole advertisement content is not desirable to the called terminal.

### Third Embodiment

FIG. 4 shows a process of a method for realizing a call-based advertisement service in an embodiment of the present invention. This embodiment enables the calling terminal to display the advertisement information customized by the called terminal when the calling terminal originates a call to the called terminal, and includes the following blocks:

Block 41: The calling terminal originates a call request directed to the called terminal.

The calling terminal sends the call request directed to the called terminal to the communication server.

Before the calling terminal originates the call request directed to the called terminal, the called terminal user needs to log in to the WEB server through a PC. Afterward, the WEB server displays a service selection page to the called terminal user. The called terminal user selects the called information display service in the home page service area in the service selection page. Afterward, the WEB server displays selection information to the called terminal. The selection information indicates whether to embed an advertisement into the called information display page. If the called terminal user chooses to embed an advertisement, the WEB server sends an advertisement information customization page to the called terminal user, and provides various classified advertisements for selection. The called terminal user may select the advertisement information according to hobbies. The advertisement information supports voice, videos, pictures, and texts.

After the called terminal user finishes selecting the advertisement information, the WEB server stores the selected advertisement information and the identifier information of the called terminal user into the background database. The identifier information includes the number of the called terminal user, and is configured to associate the advertisement information of the terminal with the terminal. In this way, in the subsequent call processing, the WEB server may generate the called information display page with embedded WEB advertisement information of the called terminal according to the advertisement information and the identifier information of the called terminal.

Block 42: After receiving the call request, the communication server returns a response to the calling terminal.

The response returned by the communication server to the calling terminal indicates that the communication server has received the call request of the calling terminal.

Block 43: The communication server forwards the call request to the called terminal.

The communication server locates the called terminal according to the call request, and forwards the call request to the called terminal.

The communication server forwards the call request to the called terminal in this way: If the called terminal and the communication server are in the same network, the communication server forwards the call request to the called terminal directly; if the called terminal and the communication server are in different networks, the communication server queries the network where the called terminal resides, and then forwards the call request to another communication server in the network, and this communication server forwards the call request to the called terminal.

Block 44: After receiving the call request, the called terminal returns a ring message to the calling terminal through the communication server. The ring message indicates that the called terminal has received the call request.

Block 45: The communication server requests the WEB server for the address of the called information display page, and the WEB server returns the address to the communication server.

The communication server requests the WEB server for the address of the called information display page with embedded WEB advertisement information of the called terminal. According to the stored advertisement information selected by the called terminal and the identifier information of the called terminal user, the WEB server generates a called information display page with embedded WEB advertisement information of the called terminal. The WEB advertisement information includes advertisement links. The WEB server returns the address information of the called information display page to the communication server. The call request carries the identifier information of the calling terminal and the called terminal. Therefore, the communication server may add the identifier information of the called terminal into the request sent to the WEB server. Afterward, because the WEB server stores the identifier information of the called terminal and the advertisement information selected by the called terminal, the WEB server may obtain the stored advertisement information selected by the called terminal according to the called terminal identifier information in the request of the communication server, and generate the called information display page.

Block 46: The communication server forwards the address information of the called information display page to the calling terminal.

Block 47: The calling terminal obtains the called information display page from the WEB server.

Based on the address information of the calling information display page, the calling terminal requests the WEB server for the called information display page of the called terminal. The WEB server sends the called information display page to the calling terminal, and the calling terminal displays the called information display page, and obtains the called terminal number information and WEB advertisement information in the called information display page.

At this time, if the calling terminal is interested in the advertisement information embedded in the called information display page, the calling terminal may click the advertisement link to view the advertisement information.

Block 48: The communication server sends the number information of calling terminal to the called terminal. The called terminal accepts the call request of the calling terminal, and sends a 200 OK message to the calling terminal through the communication server.

Block 49: After receiving the 200 OK message, the calling terminal returns an ACK response to the called terminal through the communication server.

Block 410: A conversation is established between the calling terminal and the called terminal. The calling terminal views the advertisement information of the called terminal during or after the conversation.

After the foregoing processing, the network establishes a conversation between the calling terminal and the called terminal, and the calling terminal talks with the called terminal.

During or after the conversation, the calling terminal may choose to continue viewing the called information display page of the called terminal. If the calling terminal is interested in the advertisement information embedded in the called information display page, the calling terminal may click the advertisement link to view the advertisement information.

Because the called information display page has been stored in the calling terminal all the time, this embodiment enables, the calling terminal to view the advertisement information embedded in the called information display page before and after the conversation, and to click the advertisement link to view the advertisement information, thus benefiting the called terminal. The called information display page displays the advertisement link rather than the whole advertisement content, thus preventing negative feeling to the calling terminal when the whole advertisement content is not desirable to the calling terminal.

### Fourth Embodiment

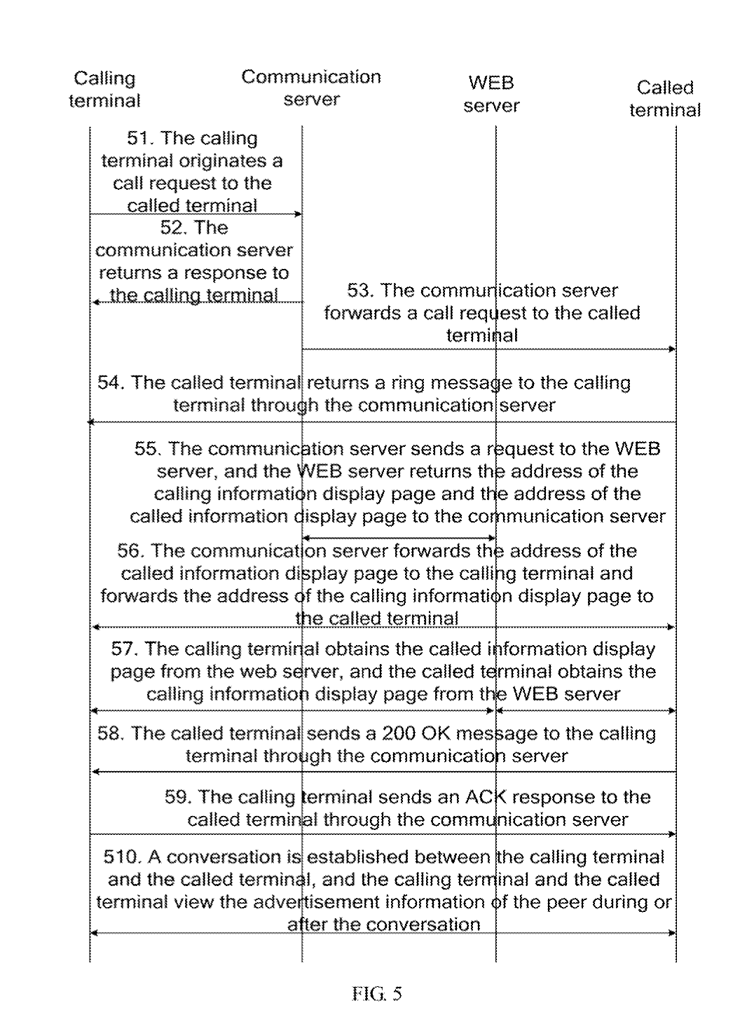

FIG. 5 shows a process of a method for realizing a call-based advertisement service in an embodiment of the present invention. This embodiment enables the calling terminal to display the advertisement information customized by the called terminal and enables the called terminal to display the advertisement information customized by the calling terminal when the calling terminal originates a call to the called terminal, and includes the following blocks:

Block 51: The calling terminal originates a call request directed to the called terminal.

The calling terminal sends the call request directed to the called terminal to the communication server.

Before the calling terminal sends the call request directed to the called terminal, the calling terminal user needs to log in to the WEB server through a PC. Afterward, the WEB server displays a service selection page to the calling terminal user. The calling terminal user selects the calling information display service in the home page service area in the service selection page. Afterward, the WEB server displays selection information to the calling terminal. The selection information indicates whether to embed an advertisement into the calling information display page. If the calling terminal user chooses to embed an advertisement, the WEB server sends an advertisement information customization page to the calling terminal user, and provides various classified advertisements for selection. The calling terminal user may select the advertisement information according to hobbies.

In the same way, the called terminal user logs in to the WEB server through the PC. Afterward, the WEB server displays a service selection page to the called terminal user. The called terminal user selects the called information display service in the home page service area in the service selection page. Afterward, the WEB server displays selection information to the called terminal. The selection information indicates whether to embed an advertisement into the called information display page. If the called terminal user chooses to embed an advertisement, the WEB server sends an advertisement information customization page to the called terminal user, and provides various classified advertisements for selection. The called terminal user may select the advertisement information according to hobbies.

After the calling terminal user and the called terminal user finish selecting the advertisement information, the WEB server stores the selected advertisement information and the identifier information of the calling terminal user and the called terminal user into the background database. The identifier information includes the number of the calling terminal user and the number of the called terminal user, and is configured to associate the advertisement information of the terminal with the terminal. In this way, in the subsequent call processing, the WEB server may generate the calling information display page with embedded WEB advertisement information of the calling terminal according to the advertisement information and the identifier information of the calling terminal user, and generate the called information display page with embedded WEB advertisement information of the called terminal according to the advertisement information and the identifier information of the called terminal user.

Block 52: After receiving the call request, the communication server returns a response to the calling terminal.

The response returned by the communication server to the calling terminal indicates that the communication server has received the call request of the calling terminal.

Block 53: The communication server forwards the call request to the called terminal.

The communication server locates the called terminal according to the call request, and forwards the call request to the called terminal.

The communication server forwards the call request to the called terminal in this way: If the called terminal and the communication server are in the same network, the communication server forwards the call request to the called terminal directly; if the called terminal and the communication server are in different networks, the communication server queries the network where the called terminal resides, and then forwards the call request to another communication server in the network, and this communication server forwards the call request to the called terminal.

Block 54: After receiving the call request, the called terminal returns a ring message to the calling terminal through the communication server. The ring message indicates that the called terminal has received the call request.

Block 54: After receiving the call request, the called terminal returns a ring message to the calling terminal through the communication server. The ring message indicates that the called terminal has received the call request.

Block 55: The communication server requests the WEB server for the address of the calling information display page and the address of the called information display page, and the WEB server returns the addresses to the communication server.

The communication server requests the WEB server for the address of the calling information display page with embedded WEB advertisement information of the calling terminal. According to the stored advertisement information selected by the calling terminal and the identifier information of the calling terminal user, the WEB server generates a calling information display page with embedded WEB advertisement information of the calling terminal. The WEB advertisement information includes advertisement links. The call request carries the identifier information of the calling terminal and the called terminal. Therefore, the communication server may add the identifier information of the calling terminal into the request sent to the WEB server. Afterward, because the WEB server stores the identifier information of the calling terminal and the advertisement information selected by the calling terminal, the WEB server may obtain the stored advertisement information selected by the calling terminal according to the calling terminal identifier information in the request of the communication server, and generate the calling information display page.

The communication server requests the WEB server for the address of the called information display page with embedded WEB advertisement information of the called terminal. According to the stored advertisement information selected by the called terminal and the identifier information of the called terminal user, the WEB server generates a called information display page with embedded WEB advertisement information of the called terminal. The WEB advertisement information includes advertisement links. The call request carries the identifier information of the calling terminal and the called terminal. Therefore, the communication server may add the identifier information of the called terminal into the request sent to the WEB server. Afterward, because the WEB server stores the identifier information of the called terminal and the advertisement information selected by the called terminal, the WEB server may obtain the stored advertisement information selected by the called terminal according to the called terminal identifier information in the request of the communication server, and generate the called information display page.

The WEB server returns the address information of the called information display page and the address information of the calling information display page to the communication server.

Block 56: The communication server forwards the address information of the called information display page to the calling terminal and forwards the address information of the calling information display page to the called terminal.

Block 57: The calling terminal obtains the called information display page from the WEB server, and the called terminal obtains the calling information display page from the WEB server.

Based on the address information of the called information display page, the calling terminal requests the called information display page of the called terminal from the WEB server. The WEB server sends the called information display page to the calling terminal, and the calling terminal displays the called information display page, and obtains the called terminal number information and WEB advertisement information in the called information display page. At this time, if the calling terminal is interested in the advertisement information embedded in the called information display page, the calling terminal may click the advertisement link to view the advertisement information.

Likewise, based on the address information of the calling information display page, the called terminal requests the WEB server for the calling information display page of the calling terminal. The WEB server sends the calling information display page to the called terminal, and the called terminal displays the calling information display page, and obtains the calling terminal number information and WEB advertisement information in the calling information display page. At this time, if the called terminal is interested in the advertisement information embedded in the calling information display page, the called terminal may click the advertisement link to view the advertisement information.

Block 58: The called terminal accepts the call request of the calling terminal, and sends a 200 OK message to the calling terminal through the communication server.

Block 59: After receiving the 200 OK message, the calling terminal returns an ACK response to the called terminal through the communication server.

Block 510: A conversation is established between the calling terminal and the called terminal. The calling terminal views the advertisement information of the called terminal during or after the conversation, and the called terminal views the advertisement information of the calling terminal during or after the conversation.

After the foregoing processing, the network establishes a conversation between the calling terminal and the called terminal, and the calling terminal talks with the called terminal.

During or after the conversation, the calling terminal may choose to continue viewing the called information display page of the called terminal. If the calling terminal is interested in the advertisement information embedded in the called information display page, the calling terminal may click the advertisement link to view the advertisement information.

Likewise, the called terminal may choose to continue viewing the calling information display page of the calling terminal. If the called terminal is interested in the advertisement information embedded in the calling information display page, the called terminal may click the advertisement link to view the advertisement information.

Because the called information display page has been stored in the calling terminal all along and the calling information display page has been stored in the called terminal all along, this embodiment enables the calling terminal and the called terminal to view the advertisement information of the peer before and after the conversation.

### Fifth Embodiment

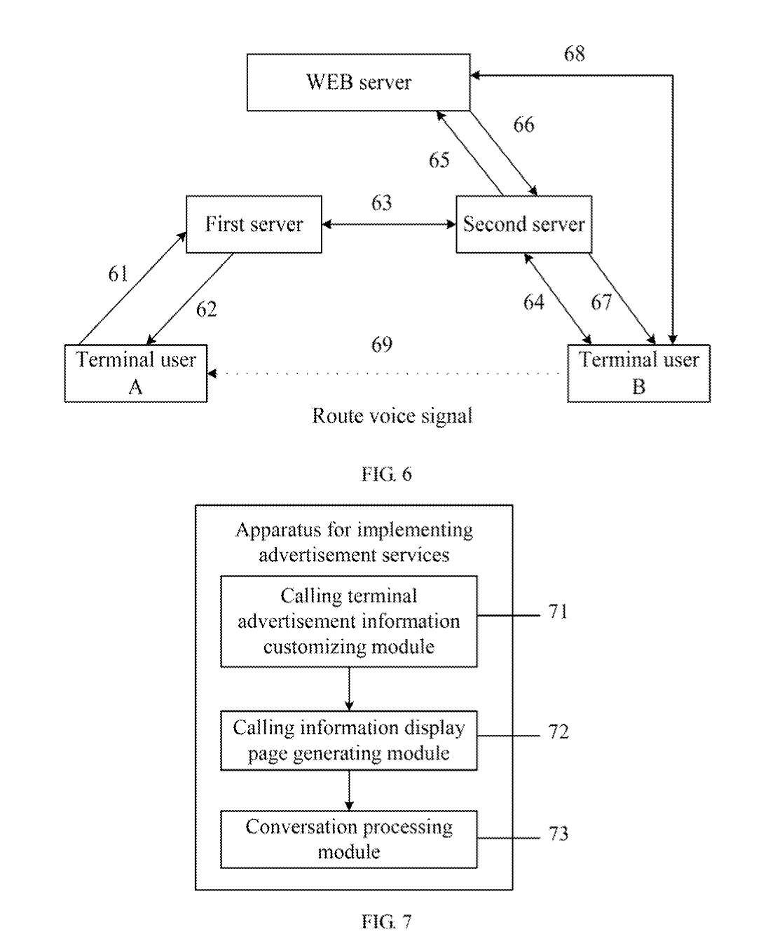

Supposing terminal user A (13632519781) originates a call to terminal user B (13632539873), a process of the method for realizing a call-based advertisement service in this embodiment is shown in FIG. 6, and includes the following blocks:

Block 61: Terminal user A originates a call request to terminal user B through a first communication server. The SIP signaling of the call request carries the following information:

INVITE 13632539873@telcom.com sip/2.0 //SIP method name;

Via: SIP/2.0/UDP 10.85.108.235:8500 //IP address and port number of the communication server;

From: UA <sip:13632519781@telcom.com>;tag=589034 //calling SIP address; the tag is generated by the system randomly for identifying the uniqueness of the process; the left side and the right side of the tag in the following SIP signaling are the same as the settings herein;

To: UB <sip: 13632539873@telcom.com> //called SIP address.

Block 62: The first communication server receives the call request of terminal user A, queries the Domain Name System (DNS) server, and locates terminal user B. The first communication server returns a 100 OK message to terminal user A, indicating that the first communication server has received the call request. The SIP signaling of the 100 OK message includes the following information:

SIP/2.0 100 Trying //response state

From: UA <sip: 13632519781@telcom.com>;tag=589304 //calling SIP address

To: UB <sip: 13632539873@telcom.com> ;tag=896325//called SIP address

Block 63: In this embodiment, terminal user A and terminal user B are in different networks. The first communication server queries the network where terminal user B resides, and forwards the call request of terminal user A to a second communication server. in the network where terminal user B resides. The second communication server returns a 100 OK message to the first communication server.

Block 64: The second communication server forwards the call request to terminal user B. After receiving the call request, terminal user B returns a 100 OK message to the second communication server.

Block 65: After receiving the 100 OK message, the second communication server sends a Uniform Resource Locator (URL) request to the WEB server to request the URL of the calling information display page of terminal user A. The SIP signaling of the URL request includes the following information:

Message sip:WEBServer@telcom.com sip/2.0 //SIP method name;

From: WSCF<sip:WSCF@ telcom.com>;tag=689114 //SIP address of the communication server;

To: WEBServer <sip:WEBServer@ telcom.com> //SIP address of the WEB server;

UA <sip:13632519781@telcom.com> //message content.

Block 66: After receiving the URL request, the WEB server obtains the pre-stored advertisement information customized by terminal user A and the identifier information of terminal user A. The identifier information includes the number of terminal user A. The WEB server generates a calling information display page with embedded advertisement information of the terminal user A according to the obtained information.

Afterward, a URL response is returned to the second communication server. The URL response carries the URL of the calling information display page of terminal user A.

The SIP signaling of the URL response includes the following information:

Message sip: WSCF@ telcom.com SIP/2.0 //SIP method name

From: WEBServer <sip:WEBServer@ telcom.com>;tag=688005 //SIP address of the WEB server

To: WSCF<sip:WSCF@ telcom.com>;tag=689114 //SIP address of the communication server

URL=HTTP://Telecom/Ads/UA080616000001 //message content

Block 67: The second communication server forwards the URL of the calling information display page of terminal user A to terminal user B.

The SIP signaling of the URL forwarded by the second communication server includes the following information:

Message sip: 13632539873@telcom.com SIP/2.0 //SIP method name

From: WSCF<sip:WSCF@ telcom.com>;tag=780254 //SIP address of the communication server

To: UB <sip: 13632539873@telcom.com> //called SIP address

URL=HTTP://Telecom/Ads/UA080616000001 //message content

Block 68: Terminal user B requests the calling information display page of terminal user A from the WEB server according to the URL. The WEB resolution function of terminal user B displays the calling information display page.

Block 69: Terminal user B sees the displayed calling number of terminal user A, and agrees to establish a call connection. Terminal user B sends a 200 OK message to terminal user A through the second communication server. After receiving the 200 OK message, terminal user A sends an ACK message to terminal user B.

Afterward, a conversation is established between terminal user A and terminal user B. Terminal user B may view the details of the calling information display page after the conversation, or, if the conversation is not affected, during the conversation. If terminal user B is interested in the advertisement information embedded in the calling information display page, terminal user B may click the advertisement link to view the advertisement information.

Through the same mechanism, the first communication server may send a URL request to the WEB server, requesting the URL of the called information display page of terminal user B. Moreover, after receiving the URL of the called information display page of terminal user B from the WEB server, the first communication server forwards the URL of the called information display page to terminal user A. Afterward, terminal user A requests the called information display page of terminal user B from the WEB server directly through the URL. It is possible that only terminal user A requests and displays the called information display page of terminal user B, or only terminal user B requests and displays the calling information display page of terminal user A, or terminal user A requests and displays the called information display page of terminal user B and terminal user B requests and displays the calling information display page of terminal user A at the same time.

In the foregoing process, the foregoing SIP signaling may be replaced with ISDN User Part (ISUP) or H.323 signaling.

It is understandable to those skilled in the art that all or part of the blocks of the foregoing embodiments may be implemented by hardware instructed by a computer program. The program may be stored in a computer-readable storage medium. When being executed, the program performs the processes covered in the foregoing embodiments. The storage medium may be a magnetic disk, a compact disk, a Read-Only Memory (ROM), or a Random Access Memory (RAM).

### Sixth Embodiment

An device for realizing a call-based advertisement service is provided in an embodiment of the present invention. As shown in FIG. 7, the device includes the following modules a calling information display page generating module 72, and a conversation processing module 73; the calling information display page generating module 72 is configured to generate a calling information display page according to the advertisement information customized by the calling terminal and the identifier information of the calling terminal after receiving the call request which is sent by the calling terminal, the call request is originated directed to the called terminal by the calling terminal; and the conversation processing module 73 is configured to: send the call request to the called terminal, send the calling information display page generated by the calling information display page generating module 72 to the called terminal, and establish a conversation between the calling terminal and the called terminal, where the calling information display page is configured for the called terminal to view the advertisement information customized by the calling terminal during or after the conversation process.

The device for realizing the advertisement service may further include a calling terminal advertisement information customizing module 71, the calling terminal advertisement information customizing module 71 is configured to: receive the login request of the calling terminal, display a service selection page to the calling terminal user, send an advertisement information customization page to the calling terminal after the calling terminal user selects the calling information display service, provide various classified advertisements for selection, and store the advertisement information selected by the calling terminal user and the identifier information of the calling terminal user, where the identifier information includes the number of the calling terminal user, and the number of the calling terminal user is configured to associate the advertisement information of the calling terminal with the calling terminal.

In this embodiment, the calling information display page is displayed throughout the communication. Therefore, the called terminal may view the advertisement on the calling advertisement page as required at any time before or after the conversation.

### Seventh Embodiment

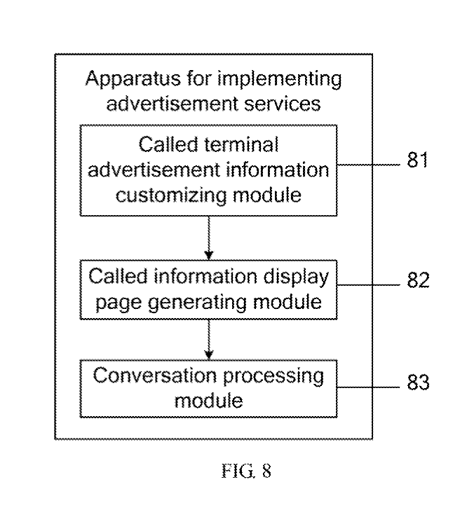

Another device for realizing a call-based advertisement service is provided in an embodiment of the present invention. As shown in FIG. 8, the device includes the following modules a called information display page generating module 82 and a conversation processing module 83; the called information display page generating module 82 is configured to generate a called information display page according to the advertisement information customized by the called terminal and the identifier information of the called terminal after receiving the call request which is sent by the calling terminal, the call request is originated directed to the called terminal by the calling terminal; and a conversation processing module 83 is configured to: send the call request to the called terminal, send the called information display page generated by the called information display page generating module 82 to the calling terminal, and establish a conversation between the calling terminal and the called terminal, where the called information display page is configured for the calling terminal to view the advertisement information customized by the called terminal during or after the conversation process.

The device may also include a called terminal advertisement information customizing module 81, and the called terminal advertisement information customizing module 81 is configured to: receive the login request of the called terminal, display a service selection page to the called terminal user, send an advertisement information customization page to the called terminal after the called terminal user selects the called information display service, provide various classified advertisements for selection, and store the advertisement information selected by the called terminal user and the identifier information of the called terminal user, where the identifier information includes the number of the called terminal user and is configured to associate the advertisement information of the called terminal with the called terminal.

In this embodiment, the called information display page is displayed throughout the communication. Therefore, the calling terminal may view the advertisement on the called advertisement page as required at any time before or after the conversation.

The device in the sixth embodiment may be combined with the device in the seventh embodiment. In this way, the device includes all the modules in both the sixth embodiment and the seventh embodiment and is capable of generating and sending both the called information display page and the calling information display page. Therefore, both the called information display page and the calling information display page are displayed throughout the conversation, and the terminal may view the advertisements in the advertisement page of the peer terminal as required at any time before or after the conversation.

### Eighth Embodiment

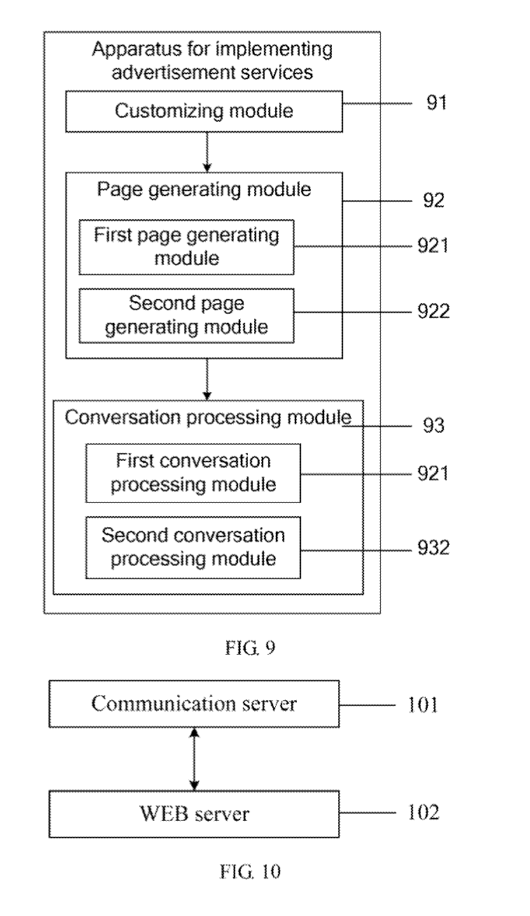

A device for realizing a call-based advertisement service is provided in this embodiment. As shown in FIG. 9, the device includes a page generating module 92 and a conversation processing module 93; the page generating module 92 is configured to: generate a calling information display page according to the advertisement information customized by the calling terminal and the identifier information of the calling terminal, and generate a called information display page according to the advertisement information customized by the called terminal and the identifier information of the called terminal after receiving the call request which is sent by the calling terminal, the call request is originated directed to the called terminal by the calling terminal; and the conversation processing module 93 is configured to: send the call request to the called terminal, send the calling information display page generated by the page generating module 92 to the called terminal, send the called information display page generated by the page generating module 92 to the calling terminal, and establish a conversation between the calling terminal and the called terminal, where: the calling information display page is configured for the called terminal to view the advertisement information customized by the calling terminal during or after the conversation process, and the called information display page is configured for the calling terminal to view the advertisement information customized by the called terminal during or after the conversation process.

The device may also include a customizing module 91, and the customizing module 91 is configured to: receive the login request of the calling terminal, display a service selection page to the calling terminal, send an advertisement information customization page to the calling terminal after the calling terminal selects the calling information display service, provide various classified advertisements for selection, and store the advertisement information selected by the calling terminal user and the identifier information of the calling terminal user;

receive the login request of the called terminal, display a service selection page to the called terminal, send an advertisement information customization page to the called terminal after the called terminal selects the called information display service, provide various classified advertisements for selection, and store the advertisement information selected by the called terminal user and the identifier information of the called terminal user.

The page generating module 92 may further include a first page generating module 921 and a second page generating module 922. The first page generating module 921 is configured to generate a calling information display page according to the advertisement information customized by the calling terminal and the identifier information of the calling terminal after receiving the call request from the calling terminal; and the second page generating module 922 is configured to generate a called information display page according to the advertisement information customized by the called terminal and the identifier information of the called terminal after receiving the call request from the calling terminal.

The conversation processing module 93 may further include a first conversation processing module 931 and a second conversation processing module 932. The first conversation processing module 931 is configured to: send the call request to the called terminal, send the calling information display page generated by the first page generating module 921 to the called terminal, and establish a conversation between the calling terminal and the called terminal, where the calling information display page is configured for the called terminal to view the advertisement information customized by the calling terminal during or after the conversation process; and the second conversation processing module 932 is configured to send the called information display page generated by the second page generating module 922 to the calling terminal, where the called information display page is configured for the calling terminal to view the advertisement information customized by the called terminal during or after the conversation process.

In this embodiment, both the calling information display page and the called information display page are displayed throughout the communication. Therefore, the terminal may view the advertisement on the calling advertisement page or the called advertisement page as required at any time before or after the conversation.

### Ninth Embodiment

A system for realizing a call-based advertisement service is provided in this embodiment. As shown in FIG. 10, the system includes a communication server 101 and the WEB server 102. The communication server 101 is configured to: receive a call request from a calling terminal, where the call request carries the identifier information of the calling terminal and the called terminal; send an information display page address request to the WEB server 102 for requesting the information display page address of the calling terminal and/or called terminal; send the information display page address to the called terminal and/or calling terminal; establish a conversation between the calling terminal and the called terminal, where the information display page address is configured for the calling terminal to view the advertisement information customized by the called terminal during or after the conversation process, and configured for the called terminal to vies the advertisement information customized by the calling terminal during or after the conversation process; and the WEB server 102 is configured to: generate an information display page according to the advertisement information customized by the terminal and the identifier information of the terminal, and return an information display page address corresponding to the identifier information to the communication server 101 according to the identifier information of terminal carried in the information display page address request of the communication server 101.

In the embodiments of the present invention, both the calling information display page and the called information display page are displayed throughout the communication. Therefore, the terminal may view the advertisement on the calling advertisement page or the called advertisement page as required at any time before or after the conversation.

In the embodiments of the present invention, the calling advertisement page and the called advertisement page are displayed through WEB pages, thus improving the interaction capability in displaying the calling information and the called information and improving the capabilities of displaying and exchanging embedded advertisements. The embodiments support the advertisement information in the form of voice, videos, pictures, and texts.

In the embodiments of the present invention, the terminal selects the advertisement information to be embedded into the calling advertisement page or the called advertisement page, thus making it easy to locate the user and reducing the waste of communication resources. Therefore, the service provider can provide more precise advertisements conveniently.

In the embodiments of the present invention, the user does not receive advertisements passively. The advertisement information is displayed to the user only if the user clicks the advertisement link to view the advertisement information when the user is interested in the advertisement information in the calling advertisement page or the called advertisement page.

Although the invention has been described through several exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for realizing an advertisement service, comprising:
receiving a call request originated by a calling terminal;
generating a calling information display page according to advertisement information customized by the calling terminal and identifier information of the calling terminal; and
sending the call request and the calling information display page to a called terminal, establishing a conversation between the calling terminal and called terminal;
wherein the calling information display page is configured for the called terminal to view the advertisement information customized by the calling terminal during or after the conversation process.

2. The method of claim 1, wherein before the receiving a call request originated by a calling terminal, the method comprises:
receiving a login of the calling terminal;
sending an advertisement customization page to the calling terminal, and providing various advertisements for the calling terminal to select; and
storing advertisement information selected by the calling terminal and the identifier information of the calling terminal.

3. The method of claim 1, wherein the advertisement information comprises at least one kind of voice, videos, pictures, and texts.

4. The method of claim 1, wherein the generating a calling information display page according to advertisement information customized by the calling terminal and identifier information of the calling terminal comprises:
sending a request for the calling information display page to a WEB server, by a communication server, the request comprising the identifier information of the calling terminal;
receiving address information of the calling information display page sent by the WEB server, and the calling information display page comprising advertisement links; and
sending the address information of the calling information display page to the called terminal, by the communication server.

5. The method of claim 1, further comprising:
receiving a call request originated by a calling terminal;
generating a called information display page according to advertisement information customized by a called terminal and identifier information of the called terminal; and
sending the call request to the called terminal, and sending the called information display page to the calling terminal, establishing a conversation between the calling terminal and called terminal;
wherein the called information display page is configured for the calling terminal to view the advertisement information customized by the called terminal during or after the conversation process.

6. The method of claim 5, wherein before the receiving a call request originated by a calling terminal, the method comprises:
receiving a login of the called terminal;
sending an advertisement customization page to the called terminal, and providing various advertisements for the called terminal to select; and
storing advertisement information selected by the called terminal and the identifier information of the called terminal.

7. The method of claim 5, wherein the generating a called information display page according to advertisement information customized by a called terminal and identifier information of the called terminal comprises:
sending a request for the called information display page to a WEB server, by a communication server, the request comprising the identifier information of the called terminal;
receiving address information of the called information display page sent by the WEB server, and the called information display page comprising advertisement links; and
sending the address information of the called information display page to the called terminal, by the communication server.

8. The method of claim 1, further comprising
receiving a call request originated by a calling terminal;
generating a calling information display page according to advertisement information customized by a calling terminal and identifier information of the calling terminal, and generating a called information display page according to advertisement information customized by the called terminal and identifier information of the called terminal; and
sending the call request to the called terminal, and sending the calling information display page to the called terminal, sending the called information display page to the calling terminal, and establishing a conversation between the calling terminal and called terminal;
wherein the calling information display page is configured for the called terminal to view the advertisement information customized by the calling terminal during or after the conversation process, and the called information display page is configured for the calling terminal to view the advertisement information customized by the called terminal during or after the conversation process.

9. The method of claim 8, wherein before the receiving a call request originated by a calling terminal, the method comprises:
receiving a login of the calling terminal, sending an advertisement customization page to the calling terminal, and providing various advertisements for the calling terminal to select, and storing advertisement information selected by the calling terminal and the identifier information of the calling terminal; and
receiving a login of the called terminal, sending an advertisement customization page to the called terminal, and providing various advertisements for the called terminal to select, and storing advertisement information selected by the called terminal and the identifier information of the called terminal.

10. The method of claim 9, wherein the generating a calling information display page according to advertisement information customized by the calling terminal and identifier information of the calling terminal, and the generating a called information display page according to advertisement information customized by a called terminal and identifier information of the called terminal, comprises:
sending a request for the called information display page to a WEB server, by a communication server, the request comprising the identifier information of the called terminal and/or the calling terminal;
receiving address information of terminal information display page sent by the WEB server, and the called information display page comprising advertisement links; and
sending the address information of terminal information display page to the corresponding terminal, by the communication server.

11. A device for realizing an advertisement service, comprising:
a first page generating module, configured to receive a call request originated by a calling terminal, and generate a calling information display page according to advertisement information customized by the calling terminal and identifier information of the calling terminal; and
a first conversation processing module, configured to send the call request and the calling information display page generated by the first page generating module to a called terminal, and establish a conversation between the calling terminal and called terminal;
wherein the calling information display page is configured for the called terminal to view the advertisement information customized by the calling terminal during or after the conversation process.

12. The device of claim 11, further comprising:
a second page generating module, configured to receive the call request originated by the calling terminal, and generate a called information display page according to advertisement information customized by a called terminal and identifier information of the called terminal; and
a second conversation processing module, configured to send the call request and the called information display page generated by the second page generating module to a calling terminal, and establish the conversation between the calling terminal and called terminal;
wherein the called information display page is configured for the calling terminal to view the advertisement information customized by the called terminal during or after the conversation process.

13. The device of claim 11, further comprising:
a customizing module, configured to receive a login of terminal, and send advertisement information customization page to the terminal, provide various advertisements for the terminal to select, and store advertisement information selected by the terminal and the identifier information of the terminal, wherein the terminal comprising the calling terminal or the called terminal.

14. The device of claim 11, further comprising
a called information generating module, configured to receive a call request originated by a calling terminal, generate a called information display page according to advertisement information customized by a called terminal and identifier information of the called terminal; and
a conversation processing module, configured to send the call request to the called terminal, send the called information display page generated by the called information generating module to the calling terminal, and establish a conversation between the calling terminal and called terminal;
wherein the called information display page is configured for the calling terminal to view the advertisement information customized by the called terminal during or after the conversation process.

15. A system for realizing an advertisement service, comprising a communication server and a WEB server, wherein
the communication server is configured to receive a call request originated by a calling terminal, send an information display address request to the WEB server for requesting information display page address of the calling terminal, send the information display page address to a called terminal, and establish a conversation between the calling terminal and the called terminal, wherein the call request comprises identifier information of the calling terminal, and the information display page is configured for the called terminal to view the advertisement information customized by the calling terminal during or after the conversation process; and
the WEB server is configured to generate information display page according to advertisement information customized by the calling terminal and identifier information of the calling terminal, and return an information display page address corresponding to the identifier information of the calling terminal carried in the information display page address request of the communication server.

16. The system of claim 15, wherein the communication server is further configured to send the information display address request to the WEB server for requesting information display page address of the called terminal, send the information display page address to the calling terminal, and establish a conversation between the calling terminal and the called terminal, wherein the call request comprises identifier information of the called terminal, and the information display page is configured for the calling terminal to view the advertisement information customized by the called terminal during or after the conversation process.

17. The system of claim 16, wherein the WEB server is further configured to generate information display page according to advertisement information customized by the called terminal and identifier information of the called terminal, and return an information display page address corresponding to the identifier information of the called terminal carried in the information display page address request of the communication server.
